(19) United States
(12) Patent Application Publication
(10) Pub. No.: US 2004/0153601 A1
(43) Pub. Date: Aug. 5, 2004

(54) General purpose lines for memory write protection

(76) Inventor: John A. Blankenagel, Aloha, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/358,454

(22) Filed: Feb. 4, 2003

(51) Int. Cl. G06F 12/00; G06F 12/14

(52) U.S. Cl. 711/103; 711/163

(57) ABSTRACT

A system provides protection against erroneous updating of a memory device by generating control signals to transfer data from a processor to the memory device where a write protect signal is provided at an interrupt input of the processor.

Flash memory devices are a special type of memory that can be erased and reprogrammed and used to store code and/or data in a single data storage component. Many modern PCs have their Basic Input/Output System (BIOS) stored on a flash memory chip so that it can be easily updated if necessary. Flash memory may be used in modems to enable the modem manufacturer to support new protocols as they become standardized. Flash memory may be used in a cellular phone to offer user-friendly features and provide design flexibility.

As manufacturers introduce faster and more powerful CPUs, there remains a system need to improve security that allows flash memory to exchange data with today's high performance CPUs more quickly, efficiently and reliably. There is a need for flash memory technology designed to provide protection that guards against erroneous code, ensuring that only authorized users can change certain settings that erase and reprogram stored memory code and/or data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram that illustrates signals used across a memory interface to support a flash memory in accordance with the present invention; and

FIG. 2 is a flow diagram that illustrates functions that may occur when a write protect signal is de-asserted by the processor to the flash memory.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact.

However, “coupled” may also mean that two or more elements are not in direct contact with each other, but yet still co-operate or interact with each other.

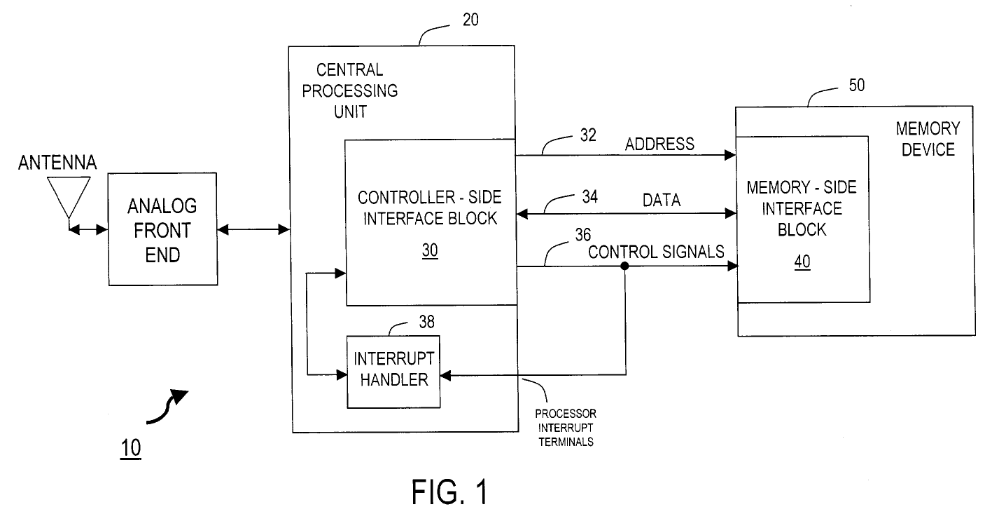

FIG. 1 illustrates an interface for a processor 20 and a memory device 50 in which the features of the present invention may be practiced. In the example illustrated, a Radio Frequency (RF) block may be coupled to processor 20 to allow wireless communications to other communication devices. Memory device may represent the BIOS that contains all the code required to control the keyboard, display screen, disk drives; serial communications, and a number of miscellaneous functions. Alternatively memory device 50 may be used to store phone directories, faxes, preferred cellular network roaming lists, short message services, voicemail, etc. Although processor 20 and memory device 50 are shown incorporated into a wireless device 10, the processor and memory may be included together in other applications that utilize a flash memory. Accordingly, embodiments of the present invention may be used in a variety of applications, with the claimed subject matter incorporated into microcontrollers, general-purpose microprocessors, baseband and application processors, Digital Signal Processors (DSPs), Reduced Instruction-Set Computing (RISC), Complex Instruction-Set Computing (CISC), among other electronic components.

In particular, the present invention may provide a signaling interface between a processor or controller and a flash memory (NAND or NOR type, including multiple bits per cell), as used in electronic systems for laptop or notebook computers, smart phones, communicators, Personal Digital Assistants (PDAs), automotive infotainment and other products. In alternate embodiments, memory device 50 may be a nonvolatile memory such as, for example, an Electrically Erasable and Programmable Read Only Memory (EEPROM), a Ferroelectric Random Access Memory (FRAM), a Polymer Ferroelectric Random Access Memory (PFRAM), a Magnetic Random Access Memory (MRAM), an Ovonics Unified Memory (OUM), or any other device capable of storing instructions and/or data. However, it should be understood that the scope of the present invention is not limited to these examples.

Included in processor 20 is a controller-side interface block 30 that is coupled to a memory-side interface block 40 in memory device 50. Interface blocks 30 and 40 represent active circuitry to provide ADDRESS signals and CONTROL signals to efficiently control DATA transfers between processor 20 and memory device 50, while ensuring that all proper timing relationships are retained. The output terminals at which the CONTROL signals are supplied may be dedicated or custom configurable General Purpose Input/Outputs (GPIO). CONTROL signals may include a Chip Enable (CE) signal, a Write Enable (WE) signal, an Output Enable (OE) signal and a Write Protect (WP) signal. The CE signal, WE signal, OE signal and WP signal supplied by processor 20 determine the mode of operation of memory device 50.

The WE signal is commonly used to indicate a signal that is asserted at the same time as CE and does the write to memory. The WP signal is used to prevent flash memory writes. Once the WE signal is asserted along with the CE signal, data is supplied to memory device 50 to be written and stored in the memory array. On the other hand, the WP signal is de-asserted by one command and the write is another command, which allows an interrupt handler 38 to take control between those commands.

In accordance with the present invention, at least one control signal, in addition to being supplied to memory device 50, is further supplied as an input to an interrupt pin of processor 20. In one embodiment, the line for the WP signal may be routed to an interrupt pin and to interrupt handler 38, and when the WP signal is de-asserted, processor 20 may be interrupted. Alternately, the line for the WP signal may be connected to an external interrupt controller device (not shown) that generates a request to the host processor on an interrupt line. The host processor responds to an interrupt request with an interrupt acknowledge and the controller device prioritizes the pending requests and returns the interrupt vector to the processor.

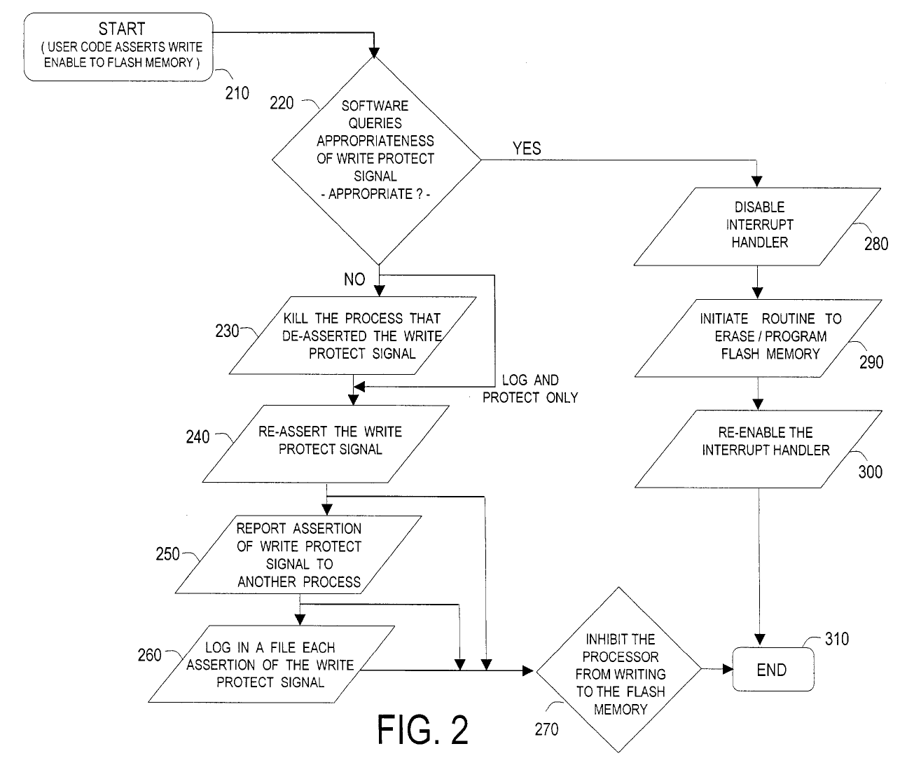

FIG. 2 is a flow diagram that illustrates decisions and functions that may occur when a WP signal is de-asserted by processor 20 for memory device 50. When the user code running in processor 20 de-asserts the WP signal to memory device 50 (Process 210), that same WP signal causes an interrupt in processor 20. If memory device 50 is intentionally being written to, a software query (Process 220) determines that the WP signal has properly been asserted. In this case interrupt handler 38 may be disabled (Process 280) to allow processor 20 to supply the appropriate ADDRESS signals, CONTROL signals, and DATA to initiate and complete the erase and program sequence (Process 290) of memory device 50. After the write sequence is complete, the processor code then re-enables interrupt handler 38 (Process 300). It should be noted that the probability of errant code disabling the interrupt handler prior to a write sequence in memory device 50 is low.

On the other hand, errant code may have de-asserted the WP signal and that event may be ascertained by interrupt handler 38 to be inappropriate (Process 220). In this case several options are available. The processor code that de-asserted the write protect signal is disabled or killed (Process 230) and the WP signal is re-asserted (Process 240). Optionally, the de-assertion of the write protect signal may be reported to another process (Process 250), and also optionally, a log file may record each occurrence of the WP signal being errantly de-asserted (Process 260). Processes 250 and 260 are not order dependent and other processes are envisioned that may be run in processor 20 without changing the scope of the present invention. However, when the WP signal is de-asserted erroneously, the process that de-asserted the WP signal is killed and the WP signal is re-asserted to effectively inhibit processor 20 from writing DATA to the flash memory device (Process 270).

By connecting the WP line to an interrupt pin, an erroneous WP signal supplied to flash memory device 50 may be detected by initiating a real-time system interrupt within processor 20. The software routine run by interrupt handler 38 determines whether the WP signal is appropriate or inappropriate, and if inappropriate, takes actions to stop the process that initiated the signal and to also re-assert the signal. Thus, the erroneous WP signals may be immediately blocked and removed without compromising the data stored in memory device 50. The routine in interrupt handler 38 may be optimized to ensure that only authorized changes are made in updating the data stored in memory device 50. It should be noted that processor 20 may support multiple memory devices 50, with the multiple WP lines connected to the interrupt pins of processor 20.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A system comprising:
a processor to supply an address, data and control signals; and
a memory coupled to the processor to receive the address, the data and the control signals, where at least one control signal is further received at an interrupt input pin of the processor.

2. The system of claim 1 wherein the memory is a flash memory.

3. The system of claim 2 wherein the at least one control signal is a write protect signal.

4. The system of claim 1 where the control signals are supplied from Input/Output ports or pins.

5. A system comprising:
a Static Random Access Memory (SRAM);
a processor coupled to the SRAM to supply an address, control signals and data; and
a flash memory coupled to the processor to receive a write protect signal, where the write protect signal is further received at an interrupt pin of the processor.

6. The system of claim 5 further comprising:
an antenna; and
an analog front end coupled to the antenna for receiving and transmitting a modulated signal, where the flash memory is used to store phone directories for a communications device that includes the processor.

7. The system of claim 5 further comprising:
an interrupt handler coupled to the interrupt pin of the processor to receive the write protect signal.

8. The system of claim 7 wherein the interrupt handler is disabled to allow the processor to supply the address, the control signals, and the data to the flash memory to update a memory program.

9. The system of claim 7 wherein the interrupt handler is enabled to allow detection of erroneous write enable signals generated by the processor.

10. A system comprising:
a processor to supply address signals, data signals and a write protect control signal, where an interrupt handler detects the write protect control signal at an interrupt pin of the processor.

11. The system of claim 10 wherein the interrupt handler monitors the interrupt pin and kills a process running in the processor that de-asserts the write protect control signal.

12. The system of claim 10 wherein the interrupt handler is disabled to allow the processor to de-assert the write protect control signal to update a Basic Input/Output System (BIOS) program stored in a flash memory.

13. A method comprising:
running a process within a processor to assert a write protect signal supplied from a processor terminal to a memory that is received at an interrupt pin of the processor.

14. The method of claim 13 further comprising:
detecting in an interrupt handler that the write protect signal received at the interrupt pin has been de-asserted.

15. The method of claim 14 wherein detecting that the write protect signal has been de-asserted, further comprising:
disabling the process that de-asserted the write protect signal.

16. The method of claim 15 further comprising:
re-asserting the write protect signal supplied to the memory in response to disabling the process.

17. The method of claim 13 further comprising:
recording occurrences in a log file related to de-asserting the write protect signal.

18. The method of claim 13 further comprising:
disabling an interrupt handler coupled to the interrupt pin to allow the processor to supply address signals, control signals, and data to the memory to initiate and complete an erase and program sequence.
